(19) United States
(12) Patent Application Publication
(10) Pub. No.: US 2014/0014309 A1
(43) Pub. Date: Jan. 16, 2014

(54) HEAT SINK AND A METHOD OF FIXING THE SAME

(71) Applicant: Aravind Nayak, Bangalore (IN)

(72) Inventor: Aravind Nayak, Bangalore (IN)

(73) Assignee: TEJAS NETWORK LIMITED, Bangalore (IN)

(21) Appl. No.: 14/008,064

(22) PCT Filed: Aug. 11, 2011
(86) PCT No.: PCT/IN11/00532

§ 371 Date: Sep. 27, 2013

(30) Foreign Application Priority Data
Mar. 31, 2011 (IN) 1099/CHE/2011

(51) Int. Cl. B23P 15/26; F28F 3/00

(52) U.S. Cl. CPC B23P 15/26; F28F 3/00
USPC 165/185; 29/890.03

(57) ABSTRACT

The invention relates to a heat sink and a method of fixing the same. In one embodiment this is accomplished by a method for bonding a heat sink and an electronic device together, wherein the heat sink including a base member and a heat radiating portion the method comprising milling the base member in the midst of the heat sink of a predetermined depth, cleaning the milled surface of the heat sink with an activator, filling the milled surface of the heat sink with an adhesive for bonding with the electronic device and placing the heat sink on the electronic device and applying force for a predetermined amount of time period.

### FIELD OF THE INVENTION

The present invention relates to a heat sink, and a method of fixing the same.

### BACKGROUND OF THE INVENTION

Developments in today's highly information-intensive society have led to remarkable improvements in performances of electronic devices. During operation of many contemporary electronic devices large amounts of heat are produced. Such heat must be quickly removed from the electronic device, to prevent the device from becoming unstable or being damaged.

Typically, a heat sink is attached to an outer surface of the device to facilitate removal of heat therefrom. A conventional heat dissipating assembly essentially comprises a heat sink, and a clamping bar. The heat sink has a base, and a plurality of fins extending upwardly therefrom. The clamping bar includes a plurality of holes for passing through the fins and also has two or more locking posts extending outwardly from two corners of the bar. A screw is provided at the extended outwardly hole of the clamping bar to engaged the heat sink with the board (example PCB). However, the clamping bar and the heat sink are two separate parts. The clamping bar must be provided over the heat sink with numerous screws to make it fixed with the heat sink. The numerous screws in the rack of a network element make the assembly unduly complicated and cumbersome. Furthermore, in operation, the screws are prone to be loosened by vibration and create noise.

Another method for placing or fixing the heat sink over the electronic devices is the use of adhesive between the two. To bond the heat sink to the electronics device, there is used an adhesive having a low heat resistance and a coefficient of thermal expansion comparable to those of the heat sink and the electronic device. However, a period of several hours up to about one day is required for the adhesive to exhibit a sufficiently large fixing strength for bonding the electronic device to the heat sink. The contact between both the surface are smooth and also there is a limitation of the surface area, the use of adhesive also not a permanent solution, as it may dismantle the heat sink from the electronic device while handling.

Thus therefore there is a need for an improved method and device securing the heat sink which overcomes the above problems and limitation.

### SUMMARY OF THE INVENTION

An aspect of the present invention is to address at least the above-mentioned problems and/or disadvantages and to provide at least the advantages described below.

Accordingly, an aspect of the present invention is to provide a method for bonding a heat sink and an electronic device together, wherein the heat sink includes a base member and a heat radiating portion the method comprising milling the base member in the midst of the heat sink of a predetermined depth, cleaning the milled surface of the heat sink with an activator, filling the milled surface of the heat sink with an adhesive for bonding with the electronic device and placing the heat sink on the electronic device and applying force for a predetermined amount of time period.

In accordance with another aspect of the present invention provide a heat sink, comprising a base member and a heat radiating portion, wherein heat radiating portion includes a plurality of fins, wherein the midst of the base member of the heat sink is grooved in order to accommodate at least one electronic device

Other aspects, advantages, and salient features of the invention will become apparent to those skilled in the art from the following detailed description, which. taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings in which:

FIG. 1 shows a heat sink in accordance with one embodiment of the present invention.

FIG. 2 shows a flow chart of a method for bonding a heat sink and an electronic device together in accordance with one embodiment of the present invention.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure.

Throughout the drawings, it should be noted that like reference numbers are used to depict the same or similar elements, features, and structures.

### DETAIL DESCRIPTION OF THE INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

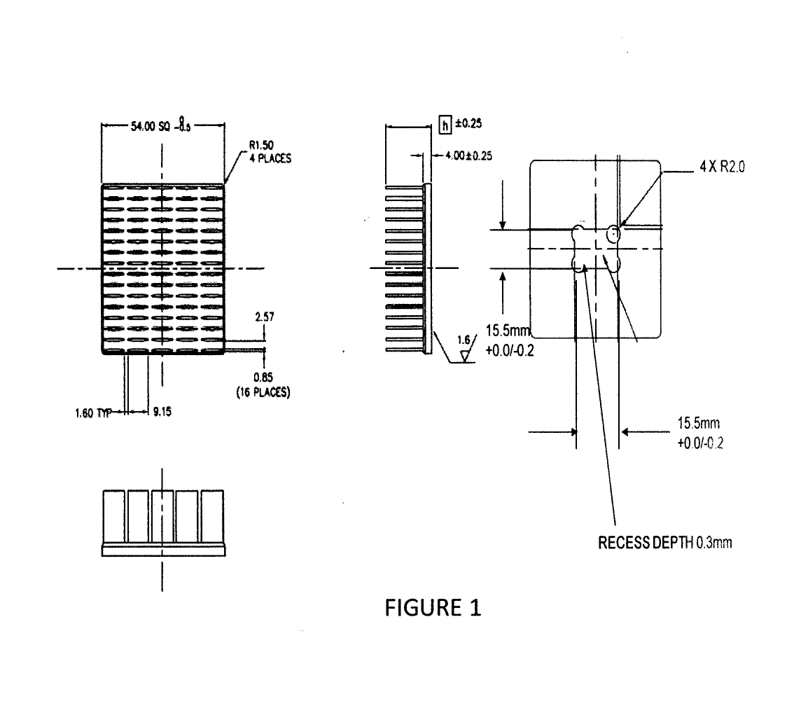

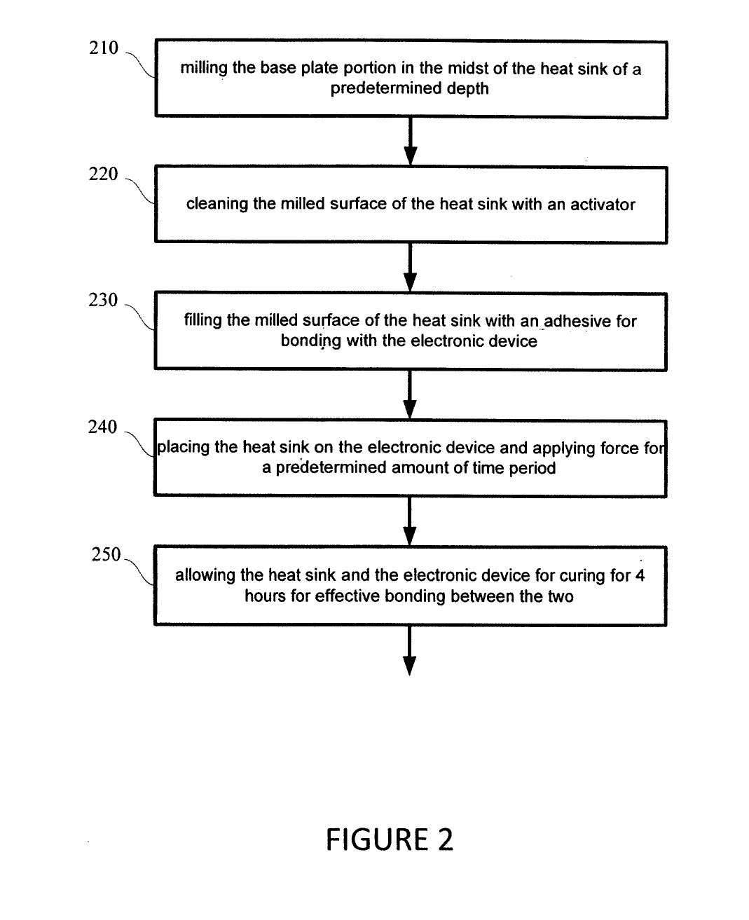

FIGS. 1 through 2, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

Referring to drawings and in particular to FIG. 1, therein is shown a pictorial view of an exemplary embodiment of a heat sink that may be used to provide thermal management of various electronic devices. In this illustrative embodiment, the heat sink may be used to provide thermal management of an electronic device, which may be virtually any type of electronic device that can benefit from thermal management. Examples include microprocessors, graphics processors, combined microprocessor/graphics processors, application specific integrated circuits, memory devices or the like, and such devices may be single core, multi-core and/or stacked in groups of multiple devices. Other examples include optical devices, such as lasers.

The heat sink includes a base member that is designed to seat on the circuit device or any electronic device. The base member advantageously provides a surface area that at least approximates the surface area of the circuit device so that a low thermal resistance pathway from the circuit device is established. The base member is advantageously constructed from a material(s) exhibiting desirable thermal conductivity. Examples include copper, nickel, aluminum, steel, combinations of these or the like. Somewhat more exotic materials, such as diamond or sapphire, could also be used for extreme thermal environments. Thermal grease (not shown) may be applied to the interface between the base member and the circuit device in order to further enhance conductive heat transfer between the two components.

In an example embodiment a heat sink, includes a base member and a heat radiating portion, wherein heat radiating portion includes a plurality of fins. The midst of the base member of the heat sink is grooved in order to accommodate at least one electronic device. The depth of the groove portion is in the range of 0.3 mm to 0.5 mm for improving the heat transfer. The preferred depth of the groove portion of the base member is 0.3 mm. The groove portion can be altered accordingly based on the electronic device which has to be used in the board. The depth of the groove portion helps in reducing the stacking length.

FIG. 2 shows a flow chart of a method for bonding a heat sink and an electronic device together in accordance with one embodiment of the present invention. At step 210, the method mills the base member in the midst of the heat sink of a predetermined depth. The milling of the base member accommodates at least one electronic device, and where the milled depth is in the range of 0.3 mm to 0.5 mm. The preferred milled depth is 0.3 mm.

At step 220, the method cleans the milled surface of the heat sink with an activator. The cleaning step is so important to ensure that there should not be any dust particle which can reduce the bonding of the base member with the electronic device. Also, the method ensures that no excess solution in the cavity of the milled region or spilled over BGA (Bill Grid Array).

At step 230, the method filled the milled surface of the heat sink with an adhesive for bonding with the electronic device. Preferably, the adhesive filled in the milled surface is a loctite 384. But it is not limited to loctite, any other equivalent type of adhesive material or glue can be used which is conductive of heat.

At step 240, the method allows to place the heat sink on the electronic device and apply force on the same for a predetermined amount of time period. The force applied is around 600 gms of weight on the heat sink for a time period of 10 minutes. The applied weight and time as a whole depends on the type of heat sink used and the type of electronic device used.

At step 250, the method allows the heat sink and the electronic device for curing for at least for 4 hours for effective bonding between the two. The curing is also depending on the material used for heat sink and also the electronics devices used in the system.

FIGS. 1-2 are merely representational and are not drawn to scale. Certain portions thereof may be exaggerated, while others may be minimized. FIGS. 1-2 illustrate various embodiments of the invention that can be understood and appropriately carried out by those of ordinary skill in the art.

In the foregoing detailed description of embodiments of the invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the detailed description of embodiments of the invention, with each claim standing on its own as a separate embodiment.

It is understood that the above description is intended to be illustrative, and not restrictive. It is intended to cover all alternatives, modifications and equivalents as may be included within the spirit and scope of the invention as defined in the appended claims. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively.

1. A method for bonding a heat sink and an electronic device together, wherein the heat sink including a base member and a heat radiating portion the method comprising:
milling the base member in the midst of the heat sink of a predetermined depth, wherein the milling the base member in order to accommodate at least one electronic device, and wherein the milled depth is in the range of 0.3 mm to 0.5 mm;
cleaning the milled surface of the heat sink with an activator;
filling the milled surface of the heat sink with an adhesive for bonding with the electronic device; and
placing the heat sink on the electronic device and applying force for a predetermined amount of time period.

2. (canceled)

3. The method of claim 1, wherein the step of cleaning further includes, ensuring no excess solution in the cavity of the milled region or spilled over Bill Gate Array (BGA).

4. The method of claim 1, wherein the adhesive filled in the milled surface is a loctite 384 or equivalent.

5. The method of claim 1, wherein the force applied is around 600 gms of weight on the heat sink for 10 minutes.

6. The method of claim 1, further comprising:
allowing the heat sink and the electronic device for curing for 4 hours for effective bonding between the two.

7. A heat sink, comprising:
a base member; and
a heat radiating portion, wherein heat radiating portion includes a plurality of fins;
wherein the midst of the base member of the heat sink is grooved in order to accommodate at least one electronic device, wherein the depth of the groove portion is in the range of 0.30 mm to 0.5 mm for improving the heat transfer.

8. The heat sink of claim 7, wherein the base member and the heat radiation portion is made up of aluminum or copper or any other material which is capable of absorbing heat from the electronic device.

9. (canceled)

10. The heat sink of claim 7, wherein the depth of the groove portion reduce the stacking length.
